(19) United States
(12) Patent Application Publication
(10) Pub. No.: US 2011/0250041 A1
(43) Pub. Date: Oct. 13, 2011

(54) Hose Loading Apparatus

(75) Inventors: Reid Wissler, Brownstown, PA (US); Jason Longenecker, Denver, PA (US); Darrin Ivers, Brandon, SD (US); Jim Salmi, Lititz, PA (US)

(73) Assignee: SPARTAN MOTORS, INC., Charlotte, MI (US)

(21) Appl. No.: 12/756,218

(22) Filed: Apr. 8, 2010

(51) Int. Cl. B60P 1/04; B66F 9/075

(52) U.S. Cl. 414/546; 414/680; 414/539; 414/812

(57) ABSTRACT

A hose loading apparatus is provided. The hose loading apparatus includes a storage bed, and an actuation arrangement. The actuation arrangement is operably connected to the storage bed. The actuation arrangement is operable to move the storage bed along an arcuate path between a raised and a lowered position to dispose the storage bed along side a vehicle. The actuation arrangement is also operable to maintain the storage bed in a horizontal orientation as the storage bed transitions between the raised and the lowered positions.

### FIELD OF THE INVENTION

This invention generally relates to firefighting and other rescue vehicles, and more particularly to storage systems used therewith.

### BACKGROUND OF THE INVENTION

Contemporary firefighting vehicles typically carry various equipment and tools to assist in fighting a fire. Certain types of these firefighting vehicles, such as pumper trucks or aerial trucks, are often configured to carry hose along with other types of firefighting equipment. This hose is rolled or folded and contained in a storage bed near the top of the vehicle commonly referred to as the hose bed. The hose bed is typically accessible from the top and rear of the vehicle. For example, the hose bed of a pumper truck is typically centered along the width of truck and accessible from the top and the rear of the truck. Similarly, the hose bed of an aerial truck is typically located in the center of the truck forward of the ladder pedestal, or off center of the width of the vehicle, and also accessible from the top and the rear of the vehicle.

To unload hose from the hose bed, an end of the hose is first tied off or anchored upon an object, e.g. a fire hydrant. The firefighting vehicle then drives away from the anchoring object, causing hose to pay out from the hose bed. As a result, unloading the hose from the hose bed is a generally simple process requiring a relatively small amount of effort on the part of a firefighter.

Unfortunately, loading the hose back in the hose bed is not as simple as unloading it. In both pumper and aerial trucks, for example, the hose bed is located above the average height of a firefighter. Due to the elevated location of the hose bed, several firefighters must stand on the ground and fold the hose into fore and aft folds. These firefighters must then reach over their heads to feed hose into the hose bed from the rear of the vehicle. Moreover, an additional firefighter must stand on top of the vehicle and assist loading the hose back into the hose bed.

Several problems arise due to the elevated position of the hose bed on the firefighting vehicle. First, firefighters are exposed to an inherent safety risk of falling off the top of the truck because they must climb about and around various equipment situated thereabout. This risk is multiplied during severe weather conditions when the top of the truck may become excessively wet or covered in ice. Second, firefighters on the ground must lift a relatively heavy load of hose over their head, thereby risking spine and other back injuries. Third, there is a risk that the firefighters loading the hose could drop it, causing it to become entangled. When the hose becomes entangled, the firefighters must stop and untangle it before any loading operations continue.

In view of the above, it is therefore desirable for a hose loading system that alleviates the safety risks and other problems associated with a top loading hose bed.

Embodiments of the invention provide such a hose loading system. These and other advantages of the invention, as well as additional inventive features, will be apparent from the description of the invention provided herein.

### BRIEF SUMMARY OF THE INVENTION

In view of the above, embodiments of the present invention provide a hose loading apparatus that overcomes existing problems in the art. More particularly, embodiments of the present invention provide a new and improved hose loading apparatus having a hose bed that transitions between a raised and a lowered position to reduce some of the risks presented by elevated stationary hose beds. Still more particularly, embodiments of the present invention provide a hose loading apparatus having an actuation arrangement capable of transitioning a hose bed between raised and lowered positions while maintaining the hose bed in a horizontal orientation, thereby reducing the risk of entanglement of hose carried within the hose bed.

In one embodiment of the invention, a hose loading apparatus is provided. The hose loading apparatus includes a storage bed, and an actuation arrangement operably connected to the storage bed. The actuation arrangement moves the storage bed along an arcuate path between a raised and a lowered position while maintaining the hose bed in a horizontal orientation. When the storage bed is in a lowered position, hose can be loaded into the storage bed by firefighters on the ground, without the need for firefighters to climb upon the top of the vehicle.

In another embodiment, the actuation arrangement connects to the storage bed at an end of the actuation arrangement. The end of the actuation arrangement travels along an arcuate path between raised and lowered positions of the storage bed. The arcuate path defines a maximum elevation point of the storage bed, the maximum elevation point disposed along the arcuate path such that the end of the actuation arrangement is at the maximum elevation point in the raised position.

In another embodiment, the maximum elevation point is disposed along the arcuate path such that the end of the actuation arrangement is at the maximum elevation point between the raised position and the lowered position. By reducing or eliminating the positive vertical displacement of the storage bed when moving between the raised position to the lowered position, other equipment stored above, or below, the storage bed will not interfere therewith during transition.

In another embodiment, the actuation arrangement is configured to maintain the storage bed in a fixed angular orientation when the storage bed transitions between the raised and the lowered position. Fixing the angular orientation of the storage bed reduces the risk of spilling or tipping the stacks of the hose stored therein during transitioning.

In another embodiment, the actuation arrangement includes an upper arm and a lower arm. The upper arm includes a first locking feature, and the lower arm includes a second locking feature. The first and second locking features are configured to cooperatively engage one another to provide lateral stability as well as support the storage bed in the raised position. According to this embodiment, the upper arm has a generally L-shaped profile formed by a leg portion and a foot portion. The first locking feature is secured to the upper side of the foot portion.

In another embodiment of the invention, a firefighting apparatus is provided. The firefighting apparatus includes a vehicle with a front end and a rear end, and having a pair of sides extending between the front and rear ends. An actuation arrangement operably couples a storage bed to the vehicle. The actuation arrangement moves the storage bed between a raised and a lowered position. The actuation arrangement transitions laterally outward relative to one of the pair of sides of the vehicle as the storage bed transitions form the raised position to the lowered position.

In another embodiment of the invention, a method of operating a storage bed attached to a vehicle is provided. The method includes transitioning the storage bed between a raised and a lowered position along a continuous arcuate path relative to the vehicle. The step of transitioning includes manipulating a control operably connected to a linear actuator of an actuation arrangement. The actuation arrangement is connected to the storage bed. Manipulating the control governs the effective length of the linear actuator, that in turn, governs the position of the actuation arrangement. The actuation arrangement is operable to transition the storage bed at an even and controlled speed.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified perspective view of an exemplary embodiment of a firefighting vehicle including a hose loading apparatus;

FIG. 2 is an exploded view of the actuation arrangement of the hose loading apparatus of FIG. 1;

FIG. 3 is a partial side view of the hose loading apparatus of FIG. 1, with a storage bed of the hose loading apparatus in a raised position;

FIG. 4 is a partial side view of the hose loading apparatus of FIG. 1, with a storage bed of the hose loading apparatus transitioning between the raised position and a lowered position;

FIG. 5 is a partial side view of the hose loading apparatus of FIG. 1, with a storage bed of the hose loading apparatus in the lowered position;

FIG. 6 is a partial side view of an alternative embodiment of an actuation arrangement of FIG. 2; and

FIG. 7 is a partial side view of a further alternative embodiment of the actuation arrangement of FIG. 2.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

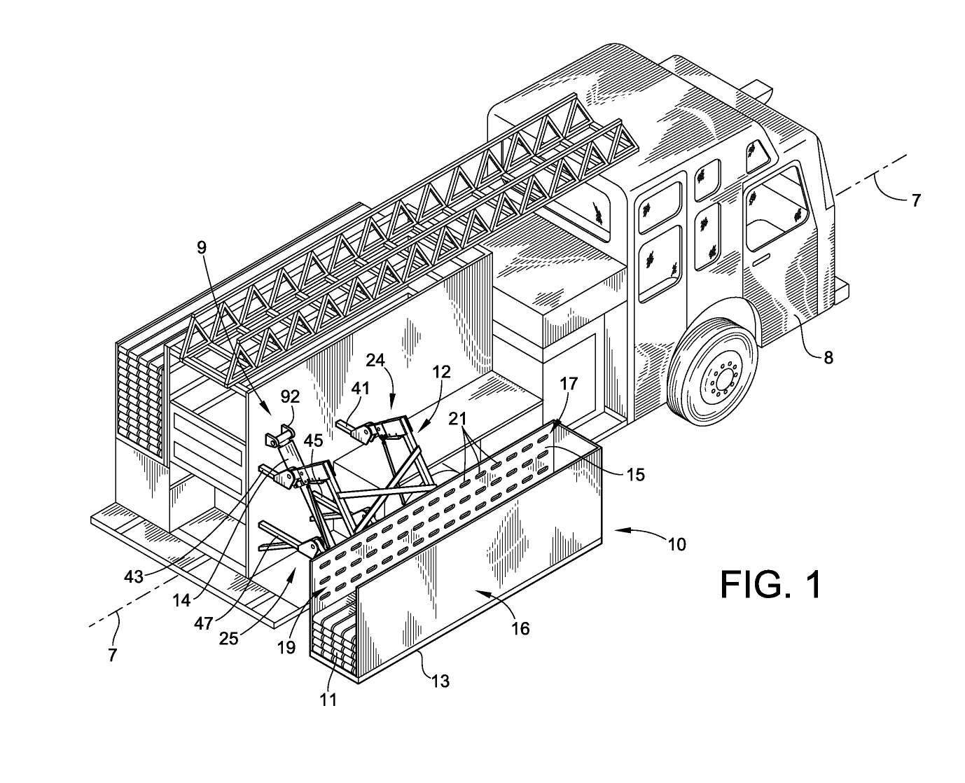

Turning now to the drawings, there is illustrated in FIG. 1 a firefighting vehicle 8, e.g. a fire truck, incorporating a hose loading apparatus 10. However, while the following description will utilize such an exemplary environment in describing various features and functionality of the present invention, such description should be taken by way of example and not by way of limitation. Indeed, advantages of embodiments of the invention can be used to improve a variety of vehicles where it is desirable to transition a storage bed to a more advantageous access point, including but not limited to rescue vehicles or other emergency response systems.

With reference now to FIG. 1, the hose loading apparatus 10 is configured to attach to the firefighting vehicle 8. In certain embodiments, the hose loading apparatus can attach to the chassis of the firefighting vehicle 8, or other portions of the firefighting vehicle 8. A firefighter can selectively transition the hose loading apparatus 10 between a raised and a lowered position, e.g. an upper storage position and a lowered deployed position, thereby allowing the firefighter to safely load hose 11 or other equipment from the ground level as opposed to climbing on the vehicle, and/or having to lift the hose 11 or other equipment overhead to load it. Bringing the hose loading apparatus 10 proximate to the ground also reduces the risk of spillage and entanglement of the hose 11 during loading.

The hose bed 16 carries the hose 11 in a neat and organized manner. The hose bed 16 is a box like structure and includes a hose bed frame 13 and an interior liner 15 mounted to the frame 13. The hose bed 16 has an open top 17 and an open front end 19. The open top 17 and open end 19 provide access to the hose 11 contained within the hose bed 16 during loading and unloading. The hose bed 16 may also be supplied with covers that cover the open top 17 and open end 19 during road travel. The covers are removable to facilitate loading and unloading hose. For example, the cover on the open end 19 may be removed to unload hose from the open end 19. As another example, the cover on both, or one of, the open top 17 and open end 19 may be removed during loading of the hose. In the illustrated embodiment, hose 11 is unloaded primarily from the open end 17 by pulling the hose 11 therethrough. The hose is loaded primarily through the open top 17 and the open end 19 by folding the hose 11 into fore and aft folds and stacking it in adjacent stacks in the hose bed 10.

Still referring to FIG. 1, the liner 15 covers the interior of the hose bed frame 13. The liner 15 has a generally smooth surface to avoid damaging the hose 11 contained within the hose bed 16. The liner 15 also includes an array of openings 21. The openings 21 provide ventilation to the hose bed 16 such that any wet hose 11 contained therein will rapidly dry. In one embodiment, the openings 21 in the liner 15 pass through the bottom and an interior side of the hose bed 16, while an exterior side of the hose bed 16 has a generally smooth appearance. However, in other embodiments, the exterior side as well as other portions of the hose bed 16 can also incorporate openings 21 to further facilitate drying and draining of the hose 11.

In certain embodiments, the hose bed 16 can also be supplied with rollers to facilitate the rapid removal of the hose through the open end 19. Additionally, although not illustrated, the hose bed 16 can be supplied with hose bed dividers which separate and prevent entanglement of adjacent stacks of hose 11 contained therein. As illustrated, the hose bed 16 is configured to carry a hose 11. However, those skilled in the art will recognize that embodiments of the invention can be applied to other types of storage beds not configured to carry a hose, e.g. equipment compartments or ladder racks.

The hose loading apparatus includes an actuation arrangement 9 to transition the hose bed 16 between the raised and lowered positions. In certain embodiments, the actuation arrangement 9 transitions the hose bed 16 at a constant velocity to reduce the loading on the actuation arrangement 9 during movement. The actuation arrangement 9 comprises a linkage assembly 12 and an actuator 14. The linkage assembly 12 connects the hose bed 16 to the vehicle 8. The actuator 14 is operably connected between the vehicle 8 and the linkage assembly 12. During operation, the actuator 14 extends in length to thereby extend the linkage assembly 12 laterally outward from the vehicle 8 and relative to one side thereof. As a result, the hose bed 16 also extends laterally outward relative to the side of the vehicle 8. In one embodiment, the linkage assembly 12 is hingedly connected along a side of the vehicle 8, however in other embodiments, the linkage assembly 12 can be coupled to other portions of the vehicle 8 sufficient to support the hose loading apparatus 10.

With continued reference to FIG. 1, the actuator 14 is configured to drive the linkage assembly 12 between a raised and a lowered position. In the lowered position, the hose bed 16 is proximate to the ground and laterally offset from the firefighting vehicle 8, and particularly laterally offset relative to the raised position. In the raised position, the hose bed 16 is positioned at the top of the firefighting vehicle 8 and fully retracted into a side of the firefighting vehicle 8, thereby forming a portion of the side of the firefighting vehicle 8. Additionally, the hose loading apparatus 10 can be supplied as part of a new vehicle in an OEM configuration, or can be retrofitted with an existing vehicle.

As will be explained in greater detail below, the illustrated embodiment of the linkage assembly 12 presents a four bar linkage between the firefighting vehicle 8 and the hose bed 16. The four bar linkage reduces tipping or tilting of the hose bed 16 as it transitions between the raised and the lowered positions. However, in other embodiments, other types of mechanisms can be used to accomplish the objectives discussed herein.

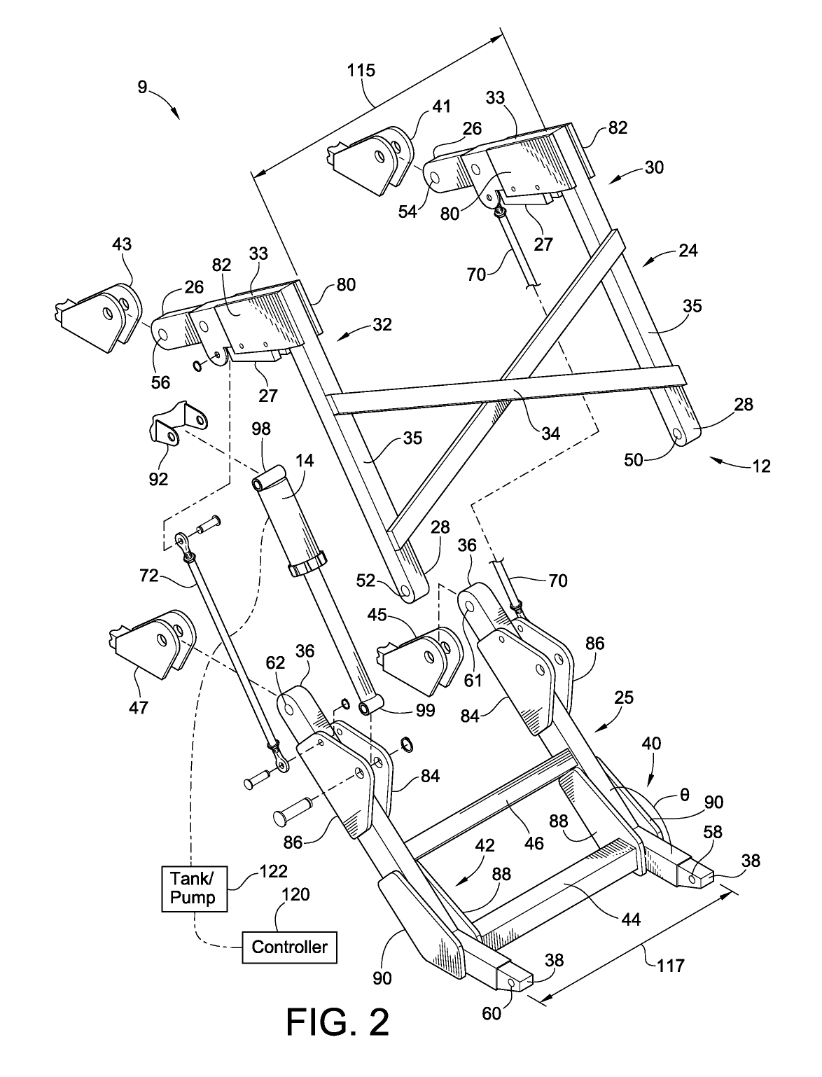

Turning now to FIG. 2, the linkage assembly 12 includes an upper arm 24 that includes a fore load bearing member 30 and an aft load bearing member 32. Each of the fore and aft load bearing members 30, 32 has a fixed end 26 and a working end 28. The fixed end 26 of each of the fore and aft load bearing members 30, 32 is hingedly connected to a fore and aft upper mounting arm 41, 43 respectively. The fore load bearing member 30 connects to the fore upper mounting arm 41 at an upper mounting point 54. Similarly, the aft load bearing member 32 connects to the aft upper mounting arm 43 at an upper mounting point 56. The upper mounting points 54, 56 are located proximate to the fixed end 26 of the fore and aft load bearing member 30, 32, respectively. In the illustrated embodiment of FIG. 2, the upper mounting points 54, 56 are through holes configured to receive a pin to facilitate the hinge type connection between the upper arm 24 and the fore and aft upper mounting arms 41, 43.

The working end 28 of each of the fore and aft load bearing members 30, 32 is hingedly connected to the hose bed 16 (see FIG. 1). More particularly, the fore load bearing member 30 connects to the hose bed 16 at an upper connection point 50 proximate the working end 28 thereof. Similarly, the aft load bearing member 32 connects to the hose bed 16 at an upper connection point 52 proximate the working end 28 thereof. In the illustrated embodiment of FIG. 2, the upper connection points 50, 52 are through holes configured to receive a pin to facilitate the hinge type connection between the upper arm 24 and the hose bed 16.

An upper lateral support 34 is fixedly connected to the fore and aft load bearing members 30, 32 to provide lateral stability thereto and to the upper arm 24 generally. The lateral support 34 generally resembles an “X” shape, however in other embodiments it can be any structure that will maintain the upper arm 24 in a structurally rigid state. In certain embodiments, the lateral support is designed to resist longitudinal forces created from loading the hose bed 16.

Still referring to FIG. 2, each of the upper connection points 50, 52 possess one rotational degree of freedom relative to the hose bed 16 (see FIG. 1). Similarly, each of the upper mounting points 54, 56 possess one rotational degree of freedom relative to the fore and aft upper mounting arms 41, 43. As such, the upper arm 24 provides planar translation when moving between the raised and the lowered positions. Although illustrated as using a fore and an aft load bearing member 30, 32, the upper arm 24 can instead utilize more load bearing members, or use a single load bearing member. However, those skilled in the art will recognize that the loading on a given load bearing member of the upper arm 24 is reduced as the number of load bearing members increases.

The upper arm 24 has a generally overall L-shaped profile as a result of corresponding L-shaped profiles of the fore and aft load bearing members 30, 32. Both of the fore and aft load bearing members 30, 32 include a foot portion 33 and a leg portion 35 extending at a generally right angle to the foot portion 33. Each of the fore and aft load bearing members 30, 32 are reinforced at the union of the foot and leg portion 33, 35 by an inner support plate 80 and an outer support plate 82. The inner and outer support plates 80, 82 reinforce each of the fore and aft load bearing members 30, 32 and also facilitate the connection of other components, as will be discussed in greater detail below.

With continued reference to FIG. 2, the linkage assembly 12 has a lower arm 25 that includes a fore and an aft load bearing member 40, 42. Each of the fore and aft load bearing members 40, 42 has a fixed end 36 and a working end 38. The fixed end 36 of each of the fore and aft load bearing members 40, 42 is hingedly connected to a fore and aft lower mounting arm 45, 47 respectively. The fore load bearing member 40 connects to the fore lower mounting arm 45 at a lower mounting point 61. Similarly, the aft load bearing member 42 connects to the aft lower mounting arm 47 at a lower mounting point 62. The lower mounting points 61, 62 are located proximate the fixed end 36 of the fore and aft load bearing members 40, 42. In the illustrated embodiment of FIG. 2, the lower mounting points 61, 62 are through holes configured to receive a pin to facilitate the hinge type connection between the lower arm 25 and the fore and aft lower mounting arms 45, 47.

The working end 38 of each of the fore and aft load bearing members 40, 42 is hingedly connected to the hose bed 16 (see FIG. 1). More particularly, the fore load bearing member 40 hingedly connects to the hose bed 16 at a lower connection point 58 proximate the working end 38 thereof. Similarly, the aft load bearing member 42 hingedly connects to the hose bed 16 at a lower connection point 60 proximate the working end 38 thereof. In the illustrated embodiment of FIG. 2, the lower connection points 58, 60 are through holes configured to receive a pin to facilitate a hinge type connection between the lower arm 25 and the hose bed 16.

A pair of lower lateral supports 44, 46 are fixedly connected to the fore and aft load bearing members 40, 42 to provide lateral stability thereto and to the lower arm 25 generally. The lower lateral supports 44, 46 are generally cross members, however in other embodiments the lower lateral supports 44, 46 can be any structure that will maintain the lower arm 25 in a structurally rigid state.

Still referring to FIG. 2, each of the lower connection points 58, 60 possess one rotational degree of freedom relative to the hose bed 16 (see FIG. 1). Similarly, each of lower mounting points 61, 62 possess one rotational degree of freedom relative to the fore and aft lower mounting arms 45, 47. In the same manner as the upper arm 24, the lower arm 25 provides planar translation when moving between the raised and the lowered positions. Although illustrated as using fore and aft load bearing members 40, 42, the lower arm 25 can instead utilize more load bearing members, or use a single load bearing member. However, those skilled in the art will recognize that the loading on a given load bearing member of the lower arm 25 is reduced as the number of load bearing members increases.

As illustrated in FIG. 2, the lower arm 25 has a bend therein resulting in an angle θ between the fixed end 36 and the working end 38 of the lower arm 25. The angled design of the lower arm 25 allows for the lower arm 25 to connect to the hose bed 16 (see FIG. 1) at an underside thereof yet still allow the lower connection points 58, 60 to be below the lower mounting points 61, 62 in the lowered position (see FIG. 5). Put another way, if the lower arm 25 was straight, and the lower connection points 58, 60 were still at an underside of the hose bed 16, the lower connection points 58, 60 would be constrained from traveling below the lower mounting points 61, 62 without some other modification to the hose bed 16, such as cutting clearance slots therein.

Each of the fore and aft load bearing members 40, 42 of the lower arm 25 includes a first set of inner and outer support plates 84, 86 and a second set of inner and outer support plates 88, 90 that support and reinforce each of the fore and aft load bearing members 40, 42 and facilitate the connection of other components, as will be discussed in greater detail below.

The fore and aft load bearing members 30, 32 of the upper arm 24 are spaced apart by a first horizontal distance 115. Similarly, the fore and aft load bearing members 40, 42 of the lower arm 25 are spaced apart by a second horizontal distance 117. The first horizontal distance 115 is greater than the second horizontal distance 117. This allows the working end 38 of the lower arm 24 to be generally in lateral alignment with the fixed end 26 of the upper arm 25 when in the raised position. As a result, a substantial portion of the lower arm 25 is contained within a space between the fore and aft load bearing members 30, 32 of the upper arm when the linkage assembly 12 is in the raised position, ultimately providing for a compact linkage assembly 12. As a further result, areas along the firefighting vehicle 8 (see FIG. 1) proximate to the linkage assembly 12 can still be utilized for equipment storage or other functions.

As will be described in greater detail below, the linkage assembly 12 is generally a lever arm, and can be described kinematically in two dimensions as a four bar mechanism. Particularly, the firefighting vehicle 8 (see FIG. 1) serves as the ground link, the upper and lower arms 24, 25 are the grounded links, and the hose bed 16 is the coupling link coupling the grounded links together. One benefit of the particular four bar mechanism design described herein is that the coupling link maintains a fixed angular orientation, i.e. remains horizontal and parallel to the ground in the case of the hose bed 16, during operation. Several benefits are introduced by maintaining a horizontal orientation of the hose bed 16. First, there is a low risk of spillage of the hose 11 (see FIG. 1) from the hose bed 16 as the hose bed 16 transitions between the raised and the lowered position. Second, there is a low risk of entanglement of adjacent stacks 96 (see FIG. 1) of the hose 11.

However, those skilled in the art will recognize that other mechanisms can also provide such a benefit. For example, the hose bed 16 could be connected between the firefighting vehicle 8 with a single arm and include an additional stabilization mechanism such as a torque motor to maintain the hosebed 16 in a horizontal orientation.

Still referring to FIG. 2, a pair of tie rods 70, 72 connect the upper arm 24 to the lower arm 25. One tie rod 70 extends between the fore load bearing members 30, 40 of the upper and lower arms 24, 25 respectively. The tie rod 70 connects to the fore load bearing member 30 of the upper arm 24 proximate to, or in other embodiments at, the inner support plate 80. The tie rod 70 connects to the fore load bearing member 40 of the lower arm 25 at the outer support plate 86 of the first set of inner and outer support plates 84, 86.

Similarly, the other tie rod 72 extends between the aft load bearing members 32, 42 of the upper and lower arms 24, 25 respectively. The tie rod 72 connects to the aft load bearing member 30 of the upper arm 24 proximate to, or in other embodiments at, the inner support plate 80. The tie rod 72 connects to the aft load bearing member 42 of the lower arm 25 at the outer support plate 86 of the first set of inner and outer support plates 84, 86. The tie rods 70, 72 add structural support to the linkage assembly 12 and also reduce the mechanical delay time between rotation of the upper arm 24 at the upper mounting points 54, 56 and the lower arm 25 at the lower mounting points 61, 62 that is otherwise present between the lower arm 24, hose bed 16 (see FIG. 1), and upper arm 25. Additionally, the tie rods 70, 72 provide stabilization between the upper and lower arms 24, 25, as the actuation arrangement 9 (see FIG. 2) travels through an over center condition.

With continued reference to FIG. 2, the actuation arrangement 9 includes an actuator 14 that drives the linkage assembly 12 between the raised and lowered position. The actuator 14 is a linear actuator, e.g. a hydraulic, pneumatic or electric piston, screw drive, servo motor, or magnetic linear actuator. The actuator 14 has a fixed end 98 and a working end 99. The fixed end 98 is connected to an actuator mounting bracket 92 of the firefighting vehicle 8. The working end 99 is connected to the lower arm 25 of the linkage assembly 12. Specifically, the working end 99 of the actuator 14 is connected to the aft load bearing member 42 of the lower arm 25. More specifically, the working end 99 is connected to the first set of inner and outer support plates 84, 86 of the aft load bearing member 42 of the lower arm 25. However, in other embodiments the working end 99 of the actuator 14 can be connected to the fore load bearing member 40 of the lower arm 25, or in the alternative, to either of the fore or aft load bearing members 30, 32 of the upper arm 24.

Although illustrated as a linear actuator, the actuator 14 can take the form of other actuation systems. For example, the actuator 14 can be a motor providing a rotation at any of the upper or lower mounting points 54, 56, 61, 62, or any of the upper or lower connection points 50, 52, 58, 60. Indeed, all that is required for proper actuation of the linkage assembly 12 is a torque to be applied to either the upper arm 24 or the lower arm 25 about their respective mounting points 54, 56, 61, 62. Additionally or in the alternative, the actuator 14 can supplied as a plurality of linear actuators arranged in parallel to one another such that each one of the plurality of linear actuators imparts a parallel force upon the linkage assembly 12. For example, the actuation arrangement 9 could be supplied with a pair of linear actuators 14, one of which could be connected to the fore load bearing member 40 of the lower arm 25, while the other could be connected to the aft load bearing member 42 of the lower arm 25.

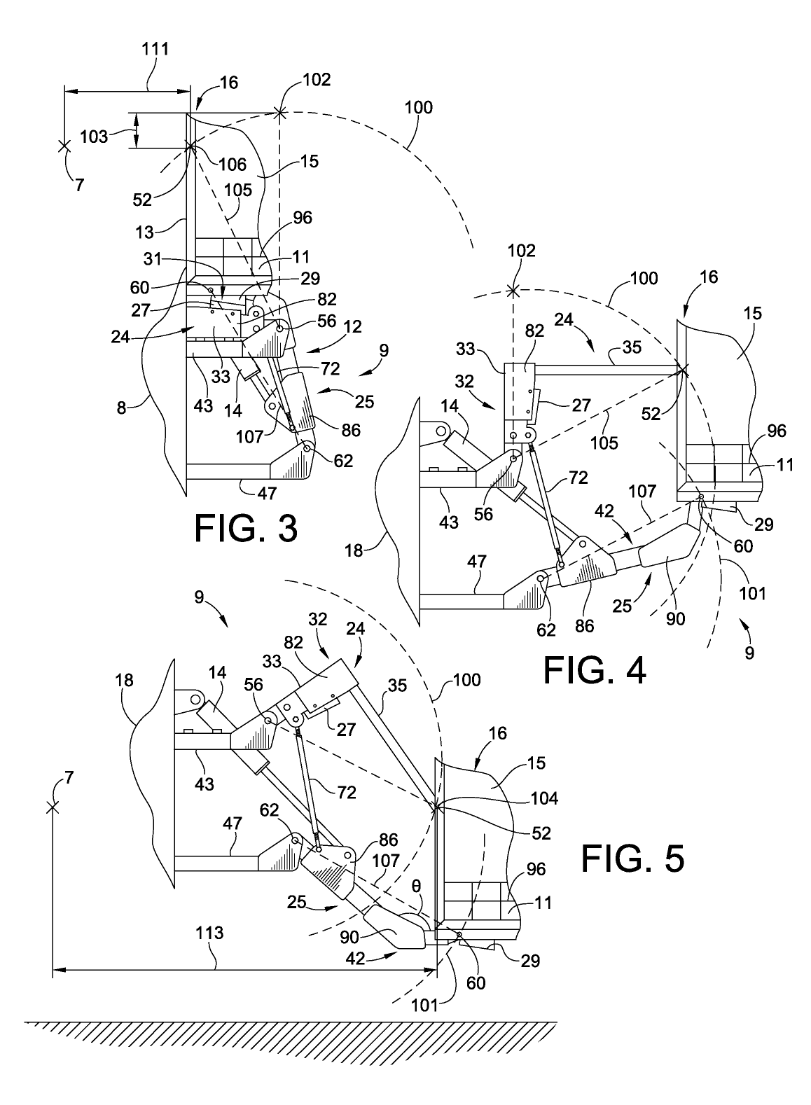

The various orientations of the upper arm 24 and lower arm 25 will now be described when the hose loading apparatus 10 is in the raised position (FIG. 3), an intermediate position (FIG. 4), and a lowered position (FIG. 5).

Turning now to FIG. 3, the hose bed 16 is illustrated in the raised position. In the raised position, the hose bed 16 nests against the upper arm 24 to reduce the overall footprint of the hose loading apparatus 10 when in the raised position. The foot portion 33 of the upper arm 24 has a first support pad 27 affixed to an upper side (in the raised position) of the foot portion 33. The hose bed 16 has a second support pad 29 affixed to an underside thereof. When the hose loading apparatus 10 is in the raised position, the first and second support pads 27, 29 abut and preferably interlock to form a locking block arrangement 31. The locking block arrangement 31 reduces unwanted movement of the hose bed 16 when the hose bed 16 is in the raised position.

The upper connection points 50, 52 (connection point 50 not shown in FIG. 3) are displaced by the actuation arrangement 9 from a raised position point 106 along an arcuate path 100. As a result, the hose bed 16 is likewise displaced along the arcuate path 100. A maximum elevation point 102, also along the arcuate path 100, is at a higher elevation than the raised position point 106. The distance between the raised position point 106 and maximum elevation point 102 is illustrated in FIG. 3 by distance 103. In one embodiment, the positive vertical displacement of the hose bed 16, i.e. distance 103, is about 2 to 6 inches when moving from the raised position to the lowered position. The upper connection points 50, 52 are also spaced a first horizontal distance 111 from a longitudinal center axis 7 of the vehicle 8 when in the raised position (see FIG. 1).

In other embodiments, the positive vertical displacement 103 of the hose bed 16 when transitioning from the raised position to the lowered position is zero. In such an embodiment, the upper connection points 50, 52 of the upper arm 24 will be in vertical alignment with the upper mounting points 54, 56 (mounting point 54 not shown) when the hose bed 16 is in the raised position. Those skilled in the art will recognize that by reducing or eliminating the overall vertical displacement 103, various equipment can be stored above, and not interfere with, the hose bed 16 during operation.

Turning now to FIG. 4, the hose bed 16 is illustrated in an intermediate position between the raised and the lowered positions. The straight line distance 105 between the upper mounting point 56 and the upper connection point 52 of the aft load bearing member 32 of the upper arm 24 remains fixed as the hose bed 16 transitions between the raised and the lowered positions. It is recognized that the same relationship exists between upper mounting point 54 and the upper connection point 50 of the fore load bearing member 30 of the upper arm 24, although not shown in FIG. 4. As a result, the arcuate path 100 of the upper arm 24 is circular.

Still referring to FIG. 4, the straight line distance 107 between the lower mounting point 62 and the lower connection point 60 of the aft load bearing member 42 of the lower arm 25 remains fixed as the hose bed 16 transitions between the raised and the lowered positions. It is recognized that the same relationship exists between the lower mounting point 61 and the lower connection point 58 of the fore load bearing member 40 of the lower arm 25, although not shown in FIG. 4. As a result, the arcuate path 101 of the lower arm 25 is also circular.

The straight line distances 105, 107 of the upper arm 24 and lower arm 25 described above are equal. Those skilled in the art will recognize that such a configuration results in the fixed angular orientation, i.e. horizontal or parallel to the ground, of the hose bed 16 as it transitions between the raised and the lowered position.

Although the upper arm 24 and lower arm 25 are illustrated and described as having arcuate paths 100, 101 respectively, other paths can be utilized in other embodiments. Indeed, the type and geometry of the mechanism selected will define the path of any point on the hose bed 16 as it travels between the raised and the lowered positions. Indeed, it is recognized that other mechanisms, including other forms of four bar linkages, could form the linkage assembly that will effectuate a trajectory that is different from the illustrated embodiment.

Referring now to FIG. 5, the hose bed 16 is illustrated in the lowered position in proximity to the ground. The upper connection points 50, 52 (connection point 50 not shown in FIG. 5) are coincident with a lowered position point 104 along the arcuate path 100 in the lowered position. The lowered position point 104 is at a lower elevation than the raised position point 106 and the maximum elevation point 102 along the arcuate path 100. The upper connection points 50, 52 are also a second horizontal distance 113 away from the longitudinal center axis 7 of the firefighting vehicle 8. The second horizontal distance 113 is greater than the first horizontal distance 111. As a result, the hose bed 16 extends laterally farther outward from the side of the vehicle 8 when in the lowered position than when in the raised position.

Having discussed the structural attributes of the hose loading apparatus 10, the operation of the same is provided below.

With primary reference back to FIG. 1, to unload hose 11 from the hose loading apparatus 10, a free end of the hose 11 is pulled through the open end 19 of the hose bed 16 and anchored to an object, e.g. a fire hydrant. The firefighting vehicle 8 then drives away from the object and hose 11 is unloaded from the hose bed 16.

To load hose 11 into the hose loading apparatus 10, the hose bed 16 is placed in the lowered position. To place the hose bed 16 in the lowered position, a firefighter manipulates a switch of a controller 120 (see FIG. 2) operably connected to a hydraulic tank or pump 122 of the actuator 14. Various types of switches can be used, such as those that couple directly to the hydraulic system of the linear actuator discussed above, or other electronic type switches that interface with a control system. In one embodiment, the firefighter holds the switch to lower the hose bed 16. In other embodiments, the firefighter presses the switch and the hose bed 16 automatically transitions to the lowered position, and terminated thereafter.

In embodiments incorporating electronic control, the controller 120 can be programmed such that power is supplied to the actuator 14 to bring the hose bed 16 from the raised position to the lowered position. Whatever control configuration used, the firefighter is able to abruptly stop the movement of the hose bed 16 from the raised position to the lowered position or vice versa by simply placing the switch in a neutral position, or letting go of the switch entirely.

Furthermore, the controller 120 can also incorporate various load sensors to monitor the loading of the linkage assembly 12 as it moves between the raised and the lowered position. In one embodiment, the controller 120, in combination with load sensors, is operable to provide interference detection, i.e. provide an indication that the hose bed 16, and/or the actuation arrangement 9 has encountered an object and/or a firefighter during raising or lowering the hose bed 16. In such an embodiment, the controller 120 is operable to immediately place the actuation arrangement 9 in a lock out condition such that no further translation of the hose bed 16 is permitted.

As another safety feature, the hose loading apparatus 10 can incorporate an audible alarm system. In such an embodiment, the audible alarm system presents a warning tone during the raising and lowering of the hose bed 16. The audible alarm system can be a stand alone system directly connected to the actuation arrangement 9, or in electronic communication with the controller 120 in embodiments incorporating electronic control.

As yet another safety feature, the hose loading apparatus 10 can incorporate a visual indicator in the cab area of the firefighting vehicle 8 (see FIG. 1). The visual indicator is operable to warn an operator of the hose bed 16 position, so that the operator does not attempt to move the firefighting vehicle 8 when the hose bed 16 is extended. Other features are also contemplated to ensure that the fire fighting vehicle 8 does not move when the hose bed 16 is extended. For example, the fire fighting vehicle 8 can include an electronic lock out to prevent operation of the vehicle when the hose bed 16 is extended.

Once the hose bed 16 is in a desired lowered position, the hose 11 is loaded into the hose bed 16 through the open top 17 and open end 19 of the hose bed 16. The hose 11 is loaded by folding the hose 11 into fore and aft folds and stacking each successive fold on top of the previous fold to form stacks 96 of folded hose 11. Once the hose 11 is completely loaded, the hose bed 16 is then placed back in the raised position.

In other embodiments, hose 11 can be unloaded from the hose bed 16 when in the lowered position to perform various tasks, such as periodic maintenance on the hose 11, or the hose bed 16. In such an embodiment, the hose bed 16 is transitioned from the raised position to the lowered position in a similar manner as discussed above, except that the hose bed 16 carries a full load of hose 11. Hose 11 is then removed from the hose bed 16 by pulling it through the open end 19, and/or by lifting stacks 96 of hose from the open top 17.

To place the hose bed 16 back in the raised position, the firefighter manipulates a switch of controller 120 in an opposite manner as discussed above for placing the hose bed 16 in the lowered position. The firefighter is able to abruptly stop the movement of the hose bed 16 from the lowered position to the raised position by simply placing the switch in a neutral position, or by letting go of the switch. Additionally, safety features such as interference detection and an audible alarm system as discussed above can also function while the hose bed 16 transitions from the lowered position to the raised position, and the open top 17 and/or the open end 19 can be closed using various types of removable covers.

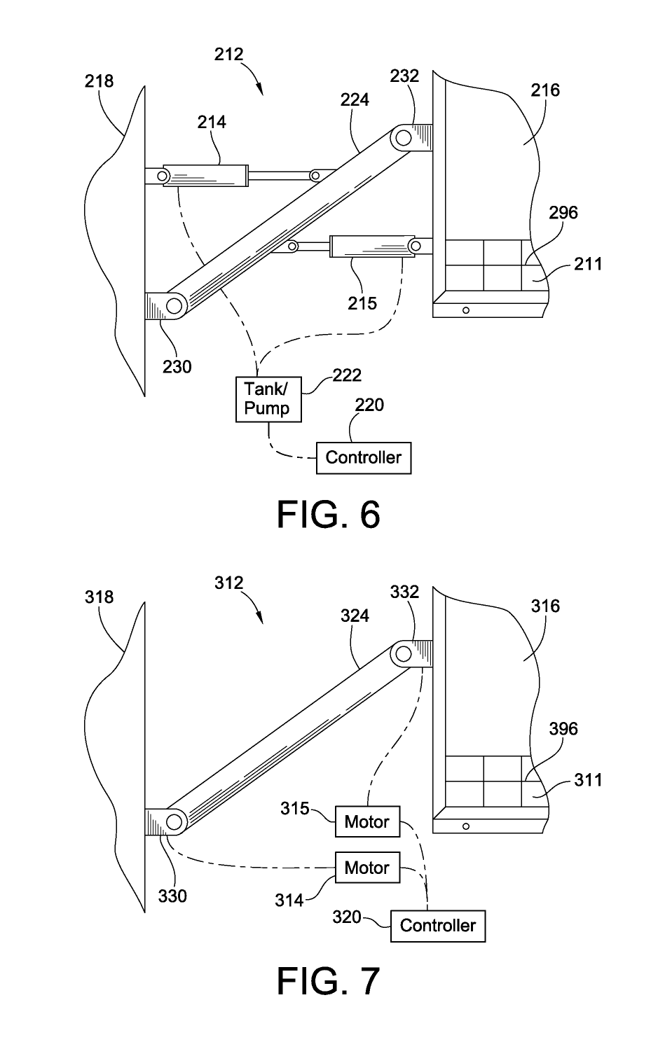

Turning now to FIG. 6, an alternative embodiment of an actuation arrangement 212 is illustrated. In the illustrated embodiment, the actuation arrangement 212 includes an arm 224 that couples a hose bed 216 to a side of a firefighting vehicle 218. The arm 224 mounts to the vehicle 218 at a first mounting hinge 230. The arm 224 mounts to the hose bed 216 at a second mounting hinge 232. The arm 224 is operable to transition the hose bed 216 between raised and lowered positions by operation of a pair of actuators 214, 215. The pair of actuators 214, 215 transition the hose bed 216 between a raised position to a lowered position such that the hose bed 216 undergoes a reduced amount of positive vertical displacement, similar to that as discussed above.

One actuator 214 is operable to drive the arm 224 towards and away from the vehicle 218, while the other actuator 215 ensures that the hose bed 216 maintains a fixed angular orientation, e.g. a horizontal orientation. In other embodiments, however, a single actuator 214 can be used, and a secondary stabilization system, e.g. a torque motor connected to the second hinge 232, can be utilized to maintain the hose bed 216 in a horizontal orientation. The actuators 214, 215 are operably connected to a hydraulic tank or pump 222 that in turn is operably coupled to a controller 220. A firefighter can transition the hose bed 216 between the raised and lowered positions by the same process discussed above. The actuators 214, 215 can be a variety of linear actuators, e.g. a hydraulic, pneumatic, or electric piston, a screw drive, a servo motor, or a magnetic linear actuator.

Still referring to FIG. 6, a single arm 224 or multiple arms 224 each having a pair of actuators 214, 215 can be used. It is recognized that by using multiple arms 224, the loading on each arm is reduced.

Turning now to FIG. 7, another alternative embodiment of an actuation arrangement 312 is illustrated. In the illustrated embodiment, the actuation arrangement 312 includes an arm 324 coupled between a hose bed 316 and a side of a firefighting vehicle 318. The arm 324 mounts to the vehicle 318 at a first mounting hinge 330. The arm 324 mounts to the hose bed 316 at a second mounting hinge 332. The arm 324 is operable to transition the hose bed 316 between raised and lowered positions by operation of a pair of motors 314, 315. The pair of motors 314, 315 transition the hose bed 316 from a raised position to a lowered position such that the hose bed 316 undergoes a reduced amount of positive vertical displacement, similar to that as discussed above.

One motor 314 is operable to drive the arm 324 towards and away from the vehicle 318, while the other motor 315 ensures that the hose bed 316 maintains a fixed angular orientation, e.g. a horizontal orientation. The motors 314, 315 are operably connected to a controller 320. A firefighter can transition the hose bed 316 between the raised and lowered positions in a similar process as that described above.

The hose loading apparatus 10 accomplishes the advantages and benefits described herein by providing a hose bed 16 that a firefighter can transition between a raised position to a lowered position by a linkage assembly 12. The linkage assembly 12 connects to the hose bed 16 in such a way as to prevent spillage or entanglement of the hose 11 while also structurally supporting the hose bed 16.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A hose loading apparatus, comprising:
a storage bed; and
an actuation arrangement operably connected to the storage bed to move the storage bed along an arcuate path between a raised and a lowered position.

2. The hose loading apparatus of claim 1 wherein the actuation arrangement connects to the storage bed at an end of the actuation arrangement, the end of the actuation arrangement travels along the arcuate path, the arcuate path defines a maximum elevation point of the storage bed, the maximum elevation point disposed along the arcuate path such that the end of the actuation arrangement is at the maximum elevation point in the raised position.

3. The hose loading apparatus of claim 1 wherein the actuation arrangement connects to the storage bed at an end of the actuation arrangement, the end of the actuation arrangement travels along the arcuate path, the arcuate path defines a maximum elevation point of the storage bed, the maximum elevation point disposed along the arcuate path such that the end of the actuation arrangement is at the maximum elevation point between the raised position and the lowered position.

4. The hose loading apparatus of claim 1 wherein the arcuate path has a constant radius.

5. The hose loading apparatus of claim 1 wherein the actuation arrangement is configured to maintain the storage bed in a fixed angular orientation when the storage bed transitions between the raised and lowered positions.

6. The hose loading apparatus of claim 5 wherein the fixed angular orientation is parallel to the ground, and wherein the actuation arrangement transitions the storage bed at a constant velocity.

7. The hose loading apparatus of claim 5 wherein the actuation arrangement includes a linkage assembly, the linkage assembly connected to the storage bed at an at least one upper connecting point, and at an at least one lower connecting point vertically spaced from the at least one upper connecting point.

8. The hose loading apparatus of claim 7 wherein the at least one upper connecting point connects to a side of the storage bed, and the at least one lower connecting point connects to a bottom of the storage bed, wherein the upper and lower connecting points are maintained in a fixed position relative to one another and hingedly couple the storage bed and the linkage assembly.

9. The hose loading apparatus of claim 7 wherein the linkage assembly includes an upper arm and a lower arm, and wherein the at least one upper connecting point is formed in a first end of the upper arm and the at least one lower connecting point is formed in a first end of the lower arm, the at least one upper and lower connecting points adapted to hingedly mount to the storage bed.

10. The hose loading apparatus of claim 9 wherein the upper arm has an at least one upper mounting point formed in a second end of the upper arm, and the lower arm has an at least one lower mounting point formed in a second end of the lower arm, the at least one upper and lower mounting points adapted to hingedly mount to an upper and lower mounting arm, respectively.

11. The hose loading apparatus of claim 9 wherein the upper arm includes a first locking feature and the storage bed includes a second locking feature, the first and second locking features configured to cooperatively engage one another to provide lateral stability and support the storage bed in the raised position, wherein the upper arm has a generally L-shaped profile formed by a leg portion and a foot portion, and wherein the first locking feature is secured to the upper side of the foot portion.

12. A firefighting apparatus, comprising:
a vehicle having a front end and a rear end, and having a pair of sides extending between the front and rear ends;
a storage bed; and
an actuation arrangement operably coupling the storage bed to the vehicle, the storage bed moveable between a raised position and a lowered position by the actuation arrangement, wherein the actuation arrangement transitions laterally outward relative to one of the pair of sides of the vehicle.

13. The firefighting apparatus of claim 12 wherein the actuation arrangement includes a linkage assembly and an actuator, wherein the linkage assembly defines an arcuate path between the raised position and the lowered position of the storage bed such that the linkage assembly undergoes a planar translation between the raised and the lowered positions, and wherein the actuator is operably connected to the linkage assembly to bias the linkage assembly between the raised and the lowered positions.

14. The firefighting apparatus of claim 13 wherein the vehicle has a first longitudinal axis extending between the front and rear ends, and wherein the linkage assembly transitions the storage bed between the raised and the lowered positions along an arcuate path that is generally orthogonal to the longitudinal axis, the linkage assembly operable to transition the storage bed such at a constant velocity.

15. The firefighting apparatus of claim 14 wherein the actuation arrangement is configured to maintain the storage bed in a fixed angular orientation.

16. The firefighting apparatus of claim 15 wherein the fixed angular orientation is parallel to the ground.

17. The firefighting apparatus of claim 13 wherein the actuation arrangement connects to the storage bed at an end of the actuation arrangement, the end of the actuation arrangement travels along the arcuate path, the arcuate path defines a maximum elevation point of the storage bed, the maximum elevation point disposed along the arcuate path such that the end of the actuation arrangement is at the maximum elevation point when in the raised position.

18. The firefighting apparatus of claim 13 wherein the actuation arrangement connects to the storage bed at an end of the actuation arrangement, the end of the actuation arrangement travels along the arcuate path, the arcuate path defines a maximum elevation point of the storage bed, the maximum elevation point disposed along the arcuate path such that the end of the actuation arrangement is at the maximum elevation point between the raised position and the lowered position.

19. The firefighting apparatus of claim 12 wherein the storage bed is configured to carry a fire hose and includes an opening at the back end thereof, and wherein the back end of the storage bed is accessible from the rear end of the vehicle when the storage bed is in the raised and the lowered position.

20. The firefighting apparatus of claim 13 wherein the actuator is linear actuator.

21. The firefighting apparatus of claim 20 wherein the linear actuator has a first end connected to the firefighting vehicle and a second end connected to the linkage assembly.

22. A method of operating a storage bed attached to a vehicle, comprising the steps of:
transitioning the storage bed between a raised position to a lowered position along a continuous arcuate path relative to a vehicle.

23. The method of claim 20 wherein the step of transitioning includes raising the storage bed from the lowered position to the raised position along the arcuate path, wherein the arcuate path defines a maximum elevation point of the storage bed and a minimum elevation point of the storage bed, wherein the maximum elevation point is between the raised position and the lowered position.

24. The method of claim 20 wherein the step of transitioning includes maintaining the storage bed in a constant angular orientation relative to vertical such that the storage bed is parallel to the ground, the step of transitioning further including transitioning the storage bed at a constant velocity.

25. The method of claim 20 wherein the step of transitioning the storage bed includes laterally extending the storage bed from a side of the vehicle and not a rear of the vehicle.

26. A fire truck equipped with a moveable side mounted fire truck hose bed, comprising:
a fire truck chassis;
a fire hose bed mounted onto a side of the fire truck chassis; and
a mechanism for moving the hose bed between a lowered deployed position and an upper storage position.

27. The fire truck equipped with a moveable side mounted fire truck hose bed of claim 26, wherein the fire hose bed remains parallel to the ground when being moved between the lowered deployed position and the upper storage position.

28. The fire truck equipped with a moveable side mounted fire truck hose bed of claim 26, wherein the hose bed has an open front end.

29. The fire truck equipped with a moveable side mounted fire truck hose bed of claim 26, wherein the mechanism comprises:
a lever arm connecting the moveable hose bed to the fire truck chassis, wherein the rotation of the lever arm moves the hose bed between the lowered deployed position and the upper storage position.

30. The fire truck equipped with a moveable side mounted fire truck hose bed of claim 29, wherein the hose bed is fully retracted into a side of the fire truck when the hose bed is in the upper storage position.
